(19) United States
(12) Patent Application Publication
(10) Pub. No.: US 2025/0283774 A1
(43) Pub. Date: Sep. 11, 2025

(54) APPARATUS, SYSTEMS, AND METHODS FOR LEAK DETECTION

(71) Applicant: Finley Miller, Long Beach, CA (US)

(72) Inventor: Finley Miller, Long Beach, CA (US)

(21) Appl. No.: 19/219,661

(22) Filed: May 27, 2025

Related U.S. Application Data
(63) Continuation-in-part of application No. 18/500,808, filed on Nov. 2, 2023.
(60) Provisional application No. 63/425,374, filed on Nov. 15, 2022.

(51) Int. Cl. G01M 3/20

(52) U.S. Cl. CPC G01M 3/20

(57) ABSTRACT

An apparatus and method for sensing local oxygen pressure are disclosed. The device features an oxygen-sensitive luminophoric material encased in both permeable and impermeable materials. By comparing the electromagnetic emissions from these materials using a Contrast Method, the local oxygen pressure is determined. Alternatively, a Discrete Luminescence Method employs a photosensor and electromagnetic wave source to excite individual luminophores and measure their luminescent output at specific locations to assess pressure levels. These technologies are useful for detecting leaks in vacuum-bag assisted manufacturing, identifying gas leak paths in solid surfaces, and other pressure-sensing applications. Both methods provide practical, cost-effective alternatives to complex imaging techniques for pressure evaluation.

### CROSS-REFERENCE TO RELATED APPLICATIONS

This application is a continuation-in-part of U.S. application Ser. No. 18/500,808, entitled, “Apparatus, Systems, and Methods for Leak Detection,” filed Nov. 2, 2023 to Miller, which claims priority to and benefit of U.S. Provisional Patent Application No. 63/425,374, to Miller, entitled “Apparatus, Systems, and Methods to Determine Pressure Gradients and Locate Leak Sources in Pressure Sensitive Manufacturing Processes Using Oxygen-Sensitive Chemicals,” filed on Nov. 15, 2022, the contents of each are incorporated by reference in their entireties.

### FIELD OF THE DISCLOSURE

The present invention relates to pressure sensors utilizing oxygen-sensitive luminophoric materials and methods for detecting local oxygen pressure. More specifically, the disclosure pertains to devices and techniques for locating leaks in manufacturing processes, detecting gas leak-paths in solid surfaces, and other pressure-sensing applications.

### BACKGROUND OF THE INVENTION

Various chemicals that can be used to provide an optical indication of the presence of oxygen have been used in oxygen sensors, in pressure sensitive paint for wind-tunnel models, in food storage applications, in medical research, and in manufacturing. The techniques that have thus far been employed in using oxygen-sensitive chemicals in vacuum processing of composites and laminates to detect and locate leaks, have never achieved widespread adoption due to cost, complexity, and difficulties in use. Air leaks continue to be a recurring issue for certain manufacturing methods used in the fabrication of composite structures. Accordingly, there is a need for methods to rapidly detect and locate leaks with equipment that is both affordable, rapid to use, and does not require unusual expertise from the operator.

There are several different classes of oxygen-sensitive chemicals that can be used to provide visual indications for the purpose of measuring vacuum levels or determining pressure gradients. The most versatile category of indicator materials is known as fluorescent dyes or luminophores. The techniques described here are novel techniques to employ already-known chemical processes and materials to specific applications related to certain manufacturing and inspection processes. Various materials can be used as a luminophoric oxygen sensor, including but not limited to H₂TSPP, H₂TCPP, H₂(Mo₂N) TFPP, PtTFPP, PtOEP, and Ru(ph₂-phen). These materials generally function by being excited by UV or visible light which causes them to emit photons as they return back to their stable ground state. When more oxygen is present, they may return to the ground state by processes that do not involve the emission of photons. The intensity and duration of that emission depends both upon the degree of stimulation and upon the concentration of oxygen in the area surrounding the sensor molecules. Other oxygen-sensitive visual indicators can also perform functions, such as UV activated non-fluorescent dyes that change color with oxygen exposure, but they have thus far proved to be inferior for a variety of reasons.

There are several known techniques for interrogating the various oxygen sensitive materials so that useful pressure information may be derived. One such technique is referred to as an “intensity method.” In the intensity method, the area of interest is covered with the oxygen sensitive material and the oxygen sensitive material is then illuminated with an excitation light. A camera is used to take a photo with a known, uniform pressure surrounding the inspection surface. The photo is called the “reference” image. Subsequently, the dynamic pressure condition is applied. For example, in the case of Wind Tunnel Modeling, the wind is turned on, which creates an uneven pressure distribution over the surface of the wind tunnel model. A second photo (“run” image) is taken in this dynamic pressure condition. The two photos are processed by a software program to create an image showing a colorized pressure gradient over the inspection surface. Because the position of the camera, the light, and the inspection area light are held constant, the change in luminescent intensity of the film surface is known to be caused by the change in local oxygen pressure and the pressure distribution across the area of interest. Variations in the applied coating or in the intensity of the excitation light, are the same in both the “reference” image and the “run image,” and therefore differences in emitted light between the two images are inferred to be due to the change in oxygen pressure. The variations are compensated for in the combined image by combining the reference and the run images, so that the pressure across the inspection area may be precisely measured. The combined image is made by applying a mathematical formula using the intensity data from each pixel of the image. The intensity of the light from the “run image” and the “reference” image are the two inputs to this formula. The calculation is run for each pixel (I/I, or some other similar ratio typically). Then a false color image is created applying color gradients that highlight where the pressure is highest across the image.

Another technique for interrogating the oxygen sensitive luminophores (luminophoric materials) to deduce local oxygen pressure is also commonly used in the wind tunnel environment, and referred to as a “Lifetime Method.” After being exposed to the excitation light, oxygen sensitive luminophores (luminophoric materials) emit photons to return to the ground state, and also may return to the ground state by oxygen quenching, as previously noted. The intensity of emission varies based on the degree of excitation and also on the surrounding concentration of oxygen. After the excitation is removed, the decay of the luminescent emission from the oxygen sensitive luminophore also varies based on the availability of oxygen. In the “Lifetime Method,” there is no need to take a reference photo with the inspection area in a condition of uniform pressure, as there is with the Intensity Method. A “reference” image is taken with the excitation light on, in the dynamic pressure environment. A “run” image is taken at a predetermined interval after the light has been turned off. Typically, the time intervals of each image are on the order of tens of microseconds, because of the brevity of the period where these materials luminesce after the excitation has been removed. In this brief duration of the effect, in some cases a series of images are collected with the excitation source strobing on and off in sync with the camera images. A composite image is then created for the “run” image, and another composite image is created for the “reference” image. The composite image provides more consistent data than a single image. The reference and run images are then typically processed using software, to create a final image showing a colorized pressure gradient across the inspection area, similar to the output from the Intensity Method. The Lifetime Method has a great advantage over the Intensity Method as it does not need to take a uniform-pressure reference image, which is often impractical. The Lifetime Method may also be more precise than the Intensity Method, because the inspection area may move when the dynamic pressure environment is engaged. For example, in the case of a wind tunnel model, it may deflect when the wind is turned on. As a result, the reference and run images may not be perfectly comparable, when using the Intensity Method, especially for higher speed testing.

In addition, various manufacturing processes use flexible impermeable films, referred to as “vacuum bags” or “vacuum bag film,” to compress materials during a manufacturing process. These manufacturing processes include fabrication of fiber-reinforced polymer composite structures, bonding of two or more articles under pressure, fabrication of laminated structures such as transparent polycarbonate laminate windows, and applying a veneer or other surface treatment. The impermeable vacuum bag film can be made from nylon, silicone rubber, or other impermeable or semi-permeable flexible polymer membranes. The key attribute of the manufacturing process is that consistent pressure can be applied over a wide area with relatively inexpensive and versatile equipment by drawing a vacuum under the film and allowing the surrounding atmospheric pressure to compress the materials. It is important that excessive air (or other gasses) cannot leak through or around the membrane since this potentially has a negative effect on the manufacturing process and on process consistency. It is therefore important to verify that no significant vacuum leaks exist, and to locate and repair them if they are detected. A variety of techniques are often used to this end, but they generally are time consuming, they sometimes are inaccurate, and they may be sensitive to operator experience and capability.

One of the highest value manufacturing applications for vacuum bags is in the manufacture of composite structures for use in aviation. New aircraft types have substantially shifted from aluminum structures to carbon fiber/epoxy structures, which may be a lighter weight while achieving the same or greater strength and stiffness. The vast majority of these structures are manufactured using vacuum bags. A typical configuration for manufacturing a carbon-fiber/epoxy composite or carbon fiber reinforced polymer (CFRP) aircraft structure is described below. The CFRP aircraft structure is an example of one of the various configurations that may benefit from these methods and devices. Typically, the uncured CFRP materials are disposed onto a rigid impermeable mold, which is designed to define the desired geometry of the final part. After the mold has been prepared, the uncured CFRP materials are deposited by any of various methods. Subsequently, ancillary materials may be positioned over the CFRP materials, which may be intended to improve surface texture, allow air evacuation, limit resin flow, or serve various other purposes. A vacuum bag is disposed over the various materials and sealed to the mold tool around the perimeter. The air between the vacuum bag and the tool is withdrawn through a port that connects to a vacuum pump. The assembly is typically checked for leaks to ensure that adequate vacuum levels are applied and that there are not undesirable air leaks into the assembly. By means of the above assembly, the CFRP is uniformly compressed during the molding process, which removes undesirable voids within the material and provides for consistent thickness and mechanical properties in the resulting structure. After the vacuum has been applied and verified, the assembly is then typically processed in an oven or autoclave (a pressurized oven) at elevated temperature, which causes a chemical reaction whereby a liquid resin solidifies around the fibrous material to form a rigid structure. After cure, the ancillary materials, including the impermeable vacuum membrane are removed, and then the part is removed from the mold and inspected. The mold is cleaned and prepared for re-use. The present description is presented to illustrate one of many applications for impermeable polymeric vacuum films in manufacturing processes. However, a person skilled in the art understands that there can be many variations on the basic process.

Building upon these established manufacturing processes and detection methods, researchers and engineers have continued to explore novel approaches for improving leak detection in vacuum-sealed composite fabrication. These efforts have led to the development of innovative techniques that aim to address the limitations of existing methods while enhancing efficiency and reliability in leak detection. For example, U.S. Pat. No. 3,612,866 to Stevens (“the '866 Patent”), issued in 1969, introduced a novel electro-optical system for measuring oxygen concentration based on the principle of fluorescence quenching. Unlike earlier techniques that required more invasive or less stable measurement methods, the '866 Patent disclosed a compact apparatus that utilized a fluorescent sensing element exposed to oxygen, whose luminescence was diminished in the presence of oxygen, and compared its output to a shielded reference element within the same environment. This dual-detection configuration, involving separate photosensitive detectors for the active and reference elements, represented an improvement in compensating for environmental variability and drift. By evaluating the relative fluorescence intensities, the system enabled more reliable and accurate quantification of oxygen concentration in real time, laying foundational groundwork for subsequent luminescence-based gas sensing technologies. While the '866 Patent introduced an innovative approach for measuring oxygen concentration, it was not specifically designed for leak detection in vacuum-sealed composite fabrication processes. The system's primary focus was on quantifying oxygen levels in various environments, rather than identifying the precise location of leaks or pressure gradients in manufacturing applications.

In 1980, Peterson and Fitzgerald (Peterson, J. I. and Fitzgerald, R. V., Rev. Sci. Instrum., 51, 670 (1980)) proposed oxygen quenching of fluorescent dyes for flow visualization in a wind tunnel. In their experiment, the luminescent dye was adsorbed onto silica particles. The coating was rough, and adherence was a problem. No attempt at quantitation was made.

Oxygen-sensitive indicators can be incorporated into transparent membranes that extend over the surface of the entire article being manufactured, for the purpose of rapidly and precisely locating leaks that may otherwise impair the manufacturing process. This technique was proposed for fabricating composite structures (Miller and Benne, U.S. Pat. No. 7,849,729B2; Miller and Benne, U.S. Pat. No. 8,505,361; Harris et al., U.S. Pat. No. 9,500,593), repairing composite structures (Thomas and Dull, U.S. Pat. No. 9,810,596), and in detecting leaks in the related molds (Miller et al., U.S. Pat. No. 8,438,909). Although it was used a number of times in the mold tool inspection application, these techniques have never achieved widespread adoption in manufacturing due to a series of limitations. One limitation is that there have been technical challenges to incorporating the materials into a satisfactory film, and the materials that have been successfully employed are very costly. A second limitation is that the equipment used in the detection process only works effectively in the dark, which is impractical for many components that are manufactured in an open factory setting. The camera system needs a dark environment to maximize the signal to noise ratio by eliminating light that is not being emitted by the oxygen sensitive dye. A third limitation is that complex photographic equipment, lighting, and image processing software must generally be used to effectively locate leaks according to previously employed methods and practices. This complexity and cost severely limit the practicality in use, particularly because specialized expertise may be required to effectively employ the system.

An additional reference includes U.S. Pat. No. 9,046,437 to Miller et al., entitled “Leak Detection in Vacuum Bags” (“the '437 Patent”). The '437 Patent discloses that air leaks in a seal beneath a vacuum bag are detected using a leak detection film inside the vacuum bag. The film includes a gas permeable binder, and a gas sensitive material held in the binder. The gas sensitive material has at least one visual characteristic that changes in the presence of gas entering the vacuum bag through a leak in the seal. This is popular with resin-infusion type composite manufacturing and claims a “double bag” method.

Still another reference is U.S. Pat. No. 8,707,766 to Harris et al., entitled, “Leak Detection Vacuum Bags” (“the '766 Patent”). The '766 Patent discloses a device that indicates the location of an air leak in a vacuum bag used to process composite parts. The device includes a layer of material on the inner face of the bag that changes in appearance due to an oxidation-reduction reaction in areas of the layer exposed to oxygen caused by a leak in the bag. Their disclosures apply to using colorimetric dye specifically, while the original indicator was based on light intensity variation (luminescent variation).

Although the potential for visual leak detection using oxygen-sensitive indicator materials has been demonstrated for vacuum bag processing, still new apparatuses, systems and methods are required to provide practical techniques for leak detection in vacuum-bag assisted manufacturing processes in locating gas leak-paths in a solid surface, or other pressure-sensing applications. Currently known methods, as described above, have not been commercially adapted due to cost, complexity and other restraints.

### BRIEF SUMMARY OF THE PRESENT INVENTION

It is an object of the present invention to provide a new apparatus and a method for sensing local oxygen pressure that are more practical than previously known techniques in certain instances.

It is another object of the present invention to provide new techniques to sense local oxygen pressure that may reduce equipment and material cost, reduce the time required to conduct the evaluation, reduce the required skill levels required by operators, and allow the evaluations to be conducted in a well-lit environment.

It is another object of the present invention to provide new techniques that can be applied to both the primary manufacturing application and to other applications where pressure measurement is required.

The present invention provides new methods for pressure sensing, referred to hereafter as a “Contrast Method” and a “Discrete Luminescence Method.” The methods have not been adapted from wind tunnel use, as the “lifetime” and “intensity” methods have been described above. The new methods use similar materials, however the method of determining the relative pressure is novel and non-obvious. The presently disclosed methods can be used in various potential pressure sensing applications, including, but not limited to, use in manufacturing processes that use transparent vacuum bags, composite fabrication, composite tooling inspection, and composite repair.

The Contrast Method: In one aspect, the present invention provides an apparatus or a pressure sensor for sensing local oxygen pressure. The apparatus includes an oxygen sensitive luminophoric material encased in a permeable material adjacent to the same or similar type of oxygen sensitive luminophoric material encased in an impermeable material. The contrast between the intensity of the electromagnetic waves emitted from each of the luminophoric materials provides an indication of the local oxygen pressure. This method of pressure sensing is referred to as the “Contrast Method.” At different oxygen pressures the oxygen sensitive luminophoric material encased in a permeable material, will change in visual appearance. The oxygen sensitive luminophoric material that is encased in an impermeable material, will not change in visual appearance regardless of the oxygen pressure. By observing the visual contrast between the oxygen sensitive materials in the different encasements, the operator may deduce the approximate oxygen pressure. When the impermeable encased luminophore is positioned adjacent to the permeable encased luminophore, this is referred to as a “Luminescent Contrast Indicator.” In an alternative configuration, the oxygen sensitive luminophore encased in an impermeable material may be temporarily placed adjacent to the oxygen sensitive luminophore encased in permeable material for evaluation, before being removed or relocated.

The Contrast Method may utilize various configurations. In one configuration, which has been used to detect pressure levels in vacuum bag processing, in the manufacture of fiber-reinforced composite structures, the Luminescent Contrast Indicator takes the form of and adhesive tape. The portion of the Indicator comprised of oxygen sensitive luminophoric dye encased in permeable material is referred to as the “Sensor Strip.” The portion of the Indicator comprised of oxygen sensitive luminophoric dye encased in impermeable material is referred to as the “Reference Strip.” In this configuration, the reference strip and the sensor strip are disposed of adjacent to each other on the non-adhesive upward facing surface of a tape. The adhesive tape may then be disposed around the perimeter of the assembly and in areas thought to be vulnerable to leakage. To interrogate the “sensor strip,” an excitation lamp, such as a UV light, is used to illuminate it. The sensor strip will react visibly when exposed to different pressures. The “reference strip,” which is positioned adjacent to the “sensor strip” is simultaneously illuminated, but will luminesce similarly regardless of the pressure environment. When there is no oxygen present, the two strips will luminesce equally, or nearly equally. The visual contrast between the “sensor strip” and the “reference strip” therefore provide a visual indication of the approximate oxygen pressure level.

A Durable, Reusable Luminescent Contrast Indicator: The Luminescent Contrast Indicator can also be produced in the form of a durable reusable device. This type of indicator has typically been produced as a one-time use, or limited-time use disposable material. The oxygen sensitive dyes have been successfully applied as an anodize coating of aluminum, and in a durable silicone elastomer coating, both of which are suitable for a durable “sensor strip.” The oxygen sensitive dyes have also been applied in an impermeable epoxy matrix, and in a durable polymer laminate film. The main limitation is that the dye can degrade with prolonged high temperature exposure, and also with prolonged UV exposure, which may limit the lifetime of a durable device. It should be understood that the luminescent contrast indicator can also be in a durable, reusable format.

The Contrast Method with an External Reference: In some instances, the Reference Strip can also be used on the outside of the test area to approximately detect the pressure. For example, in the case of vacuum bag manufacturing processes, the Reference Strip can be used as a movable article placed on or near the outer surface of the vacuum bag, while the Sensor Strip is within the vacuum bag, but observable to the operator through the transparent vacuum bag. Or the sensor strip may be embedded within the vacuum bag itself, as would be typical if an imaging method, such as the “Lifetime Method” or “Contrast Method” is also to be used. As in the previous case where the Reference Strip is within the test area, the reference strip is designed to appear identical to the sensor strip when they are both in the same oxygen concentration and illuminated similarly. For this outside-the-test-area configuration, the reference strip is again contained in a known environment. In most cases, the reference will be encased in an impermeable material, so that it will appear identical to the sensor strip when the sensor is under full vacuum. In other cases, the reference may be held in a transparent encasement that allows for a controlled and known oxygen concentration. The reference strip can thus be adjusted to various pressures so as to determine more precisely the pressure in the test area.

The Contrast Method can be applied in other form factors. For example, the Contrast Method may be applied as an alternating pattern of Sensor and Reference strips and disposed in a uniform manner across a broad area. The visual contrast is noticeable to the naked eye, and the operator may determine that the location with greatest contrast between the two types of strips has the highest oxygen pressure, and is potentially near a leak source. In some cases, a specialized device may be used that would either allow the operator to view the Luminescent Contrast Indicator in an enclosure that limits ambient light pollution. This enclosure device would illuminate the Luminescent Contrast Indicator with an electromagnetic wave designed to excite the oxygen sensitive luminophoric materials, while simultaneously allowing the operator to view or evaluate the same oxygen sensitive luminophoric materials. Or an electronic device or camera could be used to more precisely evaluate the indicator.

The Contrast Method presents certain advantages. For example, the Luminescent Contrast Indicator can be readily used by almost any operator after very brief training. In some instances, the only required equipment is a handheld UV light that costs about the same amount as a common flashlight. The Luminescent Contrast Indicator does not require image processing. As a result, the Luminescent Contrast Indicator may be faster and less disruptive to use than the previously used methods for various pressure sensing applications. Prior to this innovation, the variation in luminescent output that can be observed in the oxygen sensitive dyes is much more difficult to evaluate visually without the benefit of the adjacent Reference Strip, and therefore complex imaging methods had to be used to effectively evaluate the oxygen sensitive dye.

Advantages of the Contrast Method in vacuum bag manufacturing: The Contrast Method can be particularly useful in vacuum bag manufacturing processes because they may be used to assist in approximating the pressure under the vacuum bag film and in locating leaks. The Contrast Method may utilize various configurations for vacuum bagging. In one method, the Luminescent Contrast Indicators, including both a Sensor Strip and Reference Strip, may be disposed in various discrete locations around the perimeter of the vacuum bag, where it seals to the mold tool. In another method, the sensor strip may be disposed in discrete locations, or the sensor material may be covering the entirety of the vacuum bag surface, and the Reference Strip may be held by the operator outside of the vacuum bag, and moved around as the vacuum bag is inspected for leaks. The Contrast Method can also be used in fully lit conditions, whereas the more complex imaging methods like the “Lifetime” and “Intensity” methods may require low light conditions for successful evaluations.

Discrete Luminesce Method: In another embodiment, a new method for evaluating oxygen sensitive luminophores is utilized that can be conducted with inexpensive and rudimentary equipment in a fully lit environment. The method is referred to as a “Discrete Luminescence Method.” The Discrete Luminescence Method for evaluating oxygen sensitive luminophores relies on repeatable conditions, rather than a reference image and complex image processing. The Discrete Luminescence Method uses a handheld device, the Discrete Luminescence Method Device, which can evaluate the oxygen pressure only in a single discrete location at any one time, rather than across a broad area, as pre-existing imaging-based methodologies have done. The device contains a photosensor and an electromagnetic wave source such as an excitation light selected for its compatibility with the selected luminophore. The photosensor may have a filter on it so that only light of the approximate wavelength that is emitted from the oxygen sensitive luminophore material will be received by the photosensor. The photosensor may be a photo-voltaic, photo-emissive, photo-conductive, photo-junction, or other device that may be used to measure the intensity of an electromagnetic wave. The excitation source may be limited by a filter, so that only certain wavelengths, such as UV, are allowed to pass. The device is placed face down on the test area, and over the sensor strip. By positioning the device face down, a dark space is created that substantially eliminates ambient light. As the device is moved to evaluate various areas, the intensity of the excitation light, the position of the light intensity sensor, the ambient darkness, and other conditions, are all held constant. This eliminates the need for reference images and complex image processing, especially if the goal is just to find areas with higher or lower relative pressures.

Discrete Luminesce Method for Vacuum Bag Leak Detection: In the case of vacuum bag evaluation, the device is placed face down on the vacuum bag adjacent to the oxygen sensitive sensor strip, which is contained within the impermeable vacuum bag film. The excitation light contained within the device then illuminates the oxygen sensitive sensor strip. The light intensity sensor then measures the intensity of light being emitted by the oxygen sensitive sensor indicator material. The oxygen pressure around the oxygen sensitive sensor strip can then be ascertained by the output of the light intensity sensor via a controller including a microcontroller. In the case of a leak check, the device can be moved around to evaluate different locations and measure their relative pressures. The areas with higher pressure may be inferred to be near the source of a leak. If the sensor is to be used to measure a pressure with more accuracy, it may be necessary to develop a calibration curve for the particular configuration in use.

Combination with other Wide-Area Imaging Techniques: The Contrast Method and the Discrete Luminescence Method can also be used as a rapid and more approximate alternative to the Intensity Method or Lifetime Method. Each of the Contrast Method and the Discrete Luminescence Method can be used either as a replacement for, or a supplement to the previously known methods. For example, the Contrast Method might be used for a preliminary check in full-light conditions as a vacuum bag is being applied. Subsequently, a final check might be conducted in full darkness with a more precise Lifetime Method using a computer-controlled camera, lighting, and image processing software. The sensor strips can be used for the various methods of evaluation.

Permeable Encasement Materials: According to another embodiment, the oxygen-sensitive material can be incorporated into a polymer film, and then into an adhesive tape. Relatively permeable thermoplastics can be used for this application, such as PE, PP, FEP, PTFE, PMP, ETFE or other polymers. The tape may be a 3M® type 875 PET tape with high temperature rubber based (non-silicone) adhesive base with acrylic laminating adhesive, and oxygen sensitive UV activated dye. There may be a variety of dimensions in the manufactured tape, and in one embodiment the tape may be in the form of a standard roll of one inch in width, 0.01 inch (˜0.25 mm) thickness, 25 feet (˜7.6 m) long, and segmented into two inch (˜5 cm) long strips. The tape may have a service temperature to about 440° F. (˜204° C.) and may be degraded or destroyed by autoclave or oven use. The tape can be easily peeled off of tool surfaces and is intended to be used at room temperature prior to cure. The thermoplastic is extruded as a thin-film. Coatings with the luminophore incorporated thermosetting materials or adhesive layers such as silicones and permeable acrylics can also be used. Depending on the use condition, it may be important that the polymer has a high temperature capability. It is possible to apply the dye to a metal surface using an anodizing process as well, although this has not been demonstrated for this application. The encapsulated luminophore may then be disposed upon the mold surface around the perimeter of the seal or in other areas thought to be vulnerable to leakage. The above configuration has many of the same advantages as the solid pressure sensing disk or strip. The encapsulated luminophore may be semi-permanently disposed onto the mold surface and reused many times, and it is more practical and affordable than covering the entire part surface with a detection film. Even if used only once, the adhesive allows a much smaller area of material to be precisely positioned and held so that it is not disturbed during the application of the vacuum bag and other materials. The adhesive tape may be embossed with a surface texture to promote or limit air flow over the surface. The above configuration can be used with the various evaluation methods, including the Contrast Method, the Discrete Luminescence Method, the Intensity Method, or the Lifetime Method. In the case of the Contrast Method, the tape may be fabricated in such a way that the oxygen sensitive material is encased, in one area, by a permeable material, and in another adjacent area, by an impermeable material. In this way, the tape provides a reference strip and an adjacent sensor strip. There are many different impermeable polymers that can be used for fabricating a “Reference Indicator.” Laminate layers of polyethylene terephthalate with the oxygen sensitive luminophore dispersed between them in a layer of unsaturated polyester adhesive has been used repeatedly. In other cases, the impermeable “Reference Strip” material is produced by dispersing the oxygen sensitive luminophore in epoxy, in unsaturated polyester, or in thermosetting urethane have also been successfully used.

Conclusions: The Contrast Method and Discrete Luminescence Method may be practical to use for manufacturing applications that use vacuum bags, or for locating a leak in a weld or other surface. Unlike techniques that require manufacturing a thin transparent film which incorporate the oxygen sensor across the entirety of the surface, the new methods are low cost and requires only a very minimal modification to existing manufacturing processes, and potentially does not require requalification of the manufacturing process or materials. Large composite parts, which are manufactured using vacuum bags, can be hundreds of square meters in surface area, as in the case of boat hulls, aircraft wings, and wind turbine blades. In such examples, even a slight increase in the cost of consumable materials used in the manufacturing process may be prohibitive to adoption. By locating the sensor strips at discreet intermittent locations, the cost may be significantly reduced compared to covering an entire surface. The above configuration can be used with the various evaluation methods, including the Contrast Method, the Discrete Luminescence Method, the Intensity Method, or the Lifetime Method. In the case of the Contrast Method, the disk or strip may be fabricated to manufacture a Luminescent Contrast Indicator with the oxygen sensitive luminophore encased, in one area, by a permeable material, and in another adjacent area, by an impermeable material. In this way, the Contrast Method provides a reference strip and a sensor strip.

These various embodiments may be employed individually or all together, and provide a new method for locating leaks and measuring oxygen pressure through an impermeable film. Unlike prior methods to use oxygen-sensitive visual indicators to measure pressure and detect leaks in the vacuum bag membrane/film, the Contrast Method and the Discrete Luminescence Method are less expensive, easier to use, and do not require a dark environment to use. Although initially conceived to be used in a manufacturing process to verify vacuum integrity, they may also be used in a secondary application of evaluating a surface for cracks or leaks. In this context the system is not used during a manufacturing process. The leak detection film method has been used for evaluating the vacuum integrity of mold tools used for composite fabrication, see, for example U.S. Pat. No. 8,438,909 Miller et al. The presently disclosed new methods can also be used for that purpose, or for evaluating vacuum integrity in composite tools or for other applications, such as determining if a package has remained sealed, or determining if a crack or potential air-path in a surface extends all the way through.

### BRIEF DESCRIPTION OF THE DRAWINGS

FIG. 1 is a perspective view of a vacuum bagged composite part, having a vacuum attachment and oxygen-sensitive strips along its perimeter to detect leaks, in accordance with one embodiment of the present invention;

FIG. 2 is a perspective view of the vacuum bagged composite part having the Luminescent Contrast Indicator disposed intermittently around the perimeter of the composite part under the impermeable transparent vacuum bag film, in accordance with another embodiment of the present invention.

FIG. 3 is a perspective view of the vacuum bagged composite part, similar to FIG. 1, but having sensor patches disposed intermittently around the composite part under the impermeable transparent vacuum bag film.

FIG. 4 is a side perspective view of the vacuum bag when there is leakage, in according with one embodiment of the invention, showing a change in coloration on parts of the sensor patches, based on location of the leak.

FIG. 5 shows a cross-sectional view of the vacuum bagged composite part having a reference strip, in accordance with one embodiment of the present invention;

FIG. 6 shows a cross-sectional view similar to FIG. 5, having a portable contrast device, optical pressure sensor or an apparatus used to evaluate a sensor strip and a reference strip using a Contrast Method, in accordance with one embodiment of the present invention.

FIG. 7 shows a cross-sectional view similar to FIG. 5, having a Discrete Luminescence Device used to evaluate the sensor strip using a Discrete Luminescence Method, in accordance with one embodiment of the present invention;

FIG. 8 shows a perspective view of a Discrete Luminescence Device, in accordance with one exemplary embodiment of the present invention;

FIG. 9 shows a cross-sectional view of the device shown in FIG. 8, in accordance with one exemplary embodiment of the present invention;

FIG. 10 shows an enlarged view of a tip of the device shown in FIG. 8, in accordance with one exemplary embodiment of the present invention;

FIG. 11 shows a cross-sectional view of a substantially impermeable polymer film or vacuum bag film used in combination with a sensor strip contained within a permeable solid, in accordance with one embodiment of the present invention; and

FIG. 12 shows a block diagram of a tape presented in exploded component form, in accordance with one embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

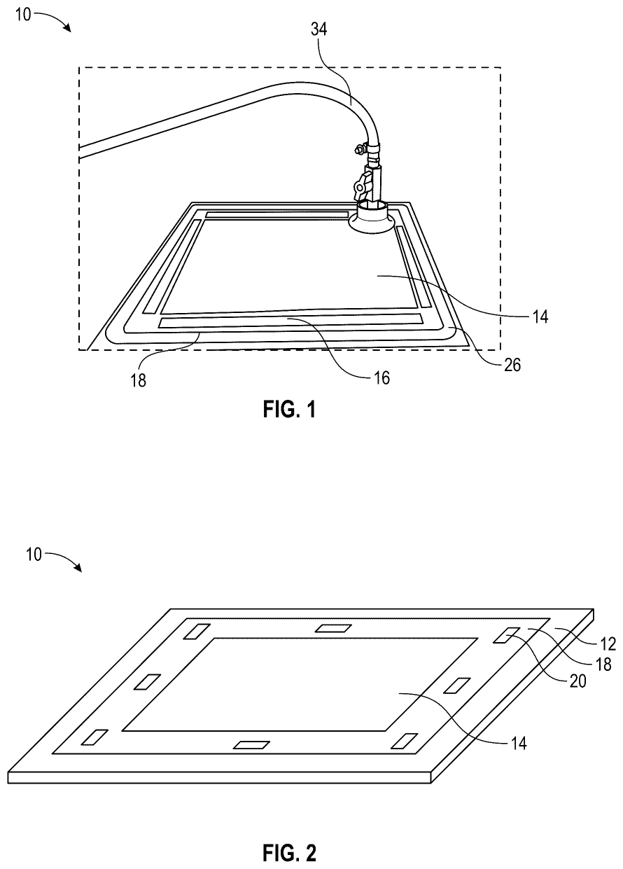

Turning to the Figures, FIG. 1 shows a vacuum bagged composite part 10 during fabrication, in accordance with one embodiment of the present invention. Vacuum bagged composite part 10 includes a rigid mold tool 12 (shown in FIG. 2) having an assembly or “preform” of composite fibers 14. Assembly or “preform” of composite fibers 14 is referred to as “preform” 14 hereinafter. Preform 14 is disposed upon rigid mold tool 12. In one example, a resin is embedded in preform 14 either before or after their disposition, using one of various methods. Typically, ancillary materials, such as breather or release film, are also disposed (not visible here) over preform 14.

Further, rigid mold tool 12 includes an oxygen-sensitive tape or strip 16. Oxygen-sensitive tape or strip 16 is disposed around the perimeter of preform 14. Further, rigid mold tool 12 includes an impermeable transparent polymer film 18. Impermeable transparent polymer film 18 is referred to as a vacuum bag film or vacuum bag 18 hereinafter. Vacuum bag film 18 is made of nylon, silicone rubber, or other impermeable or semi-permeable flexible polymer membranes. Vacuum bag film 18 is disposed over preform 14 and oxygen-sensitive strip 16 and sealed to rigid mold tool 12 with a sealant tape 26. The air contained between vacuum bag film 18 and mold tool 12 is then evacuated through a vacuum port (not shown) connected to a vacuum attachment 34, allowing the surrounding atmospheric pressure to compress the composite preform 14. Oxygen-sensitive tape or strip 16 is then evaluated to determine the pressure under vacuum bag film 18 and to aid in determining if and where any leaks may exist.

FIG. 2 shows rigid mold tool 12 having small luminescent contrast indicators 20 positioned at discreet locations under vacuum bag film 18, in accordance with one alternative embodiment of the present invention. This embodiment discloses an embodiment where small reusable indicators 20 can be used as an alternative to the conventional disposable Luminescent Contrast Indicator shown as strips 16 in FIG. 1. These small luminescent contrast indicators 20 are permeable to oxygen. In one example, oxygen-sensitive disks 20 may come in a round and flat configuration. In another example, luminescent contrast indicators 20 come in a rectangular/square and flat configuration (as shown). In one example, each luminescent contrast indicators 20 has a thickness of 0.05 inches and diameter of 2 inches. Optionally, oxygen-sensitive patch 20 has a 1-inch diameter with a suitable thickness depending on the need. luminescent contrast indicators 20 positioned at discreet locations are more practical on very large parts, or in situations where it may not be convenient to use continuous oxygen-sensitive tapes or strips 16 disposed around the perimeter of preform 14 (as shown in FIG. 1, for example). While shown as rectangular patches, the size and shape of the luminescent contrast indicators 20 may be of a variety of sizes and shapes that do not detract from the spirit of the invention. Using luminescent contrast indicators 20 may have an ancillary benefit in that they are somewhat isolated from each other by vacuum bag film 18. In other words, luminescent contrast indicators 20 are isolated from each other under vacuum bag film 18. The isolation may tend to increase the pressure differences from one disk to the next, which may help to make a leak source location more noticeable compared to using a continuous strip around the perimeter. Luminescent contrast indicators 20 may then be evaluated to determine the pressure under vacuum bag film 18 at various discrete locations and to aid in determining if and where any leaks may exist. The reusable indicators may include only the sensor (and may be referred to as a “reusable sensor strip.” This embodiment would require the use the Discrete Luminescence Device or it may include the sensor and reference strip, in which case it would act as a “reusable luminescent contrast indicator.”

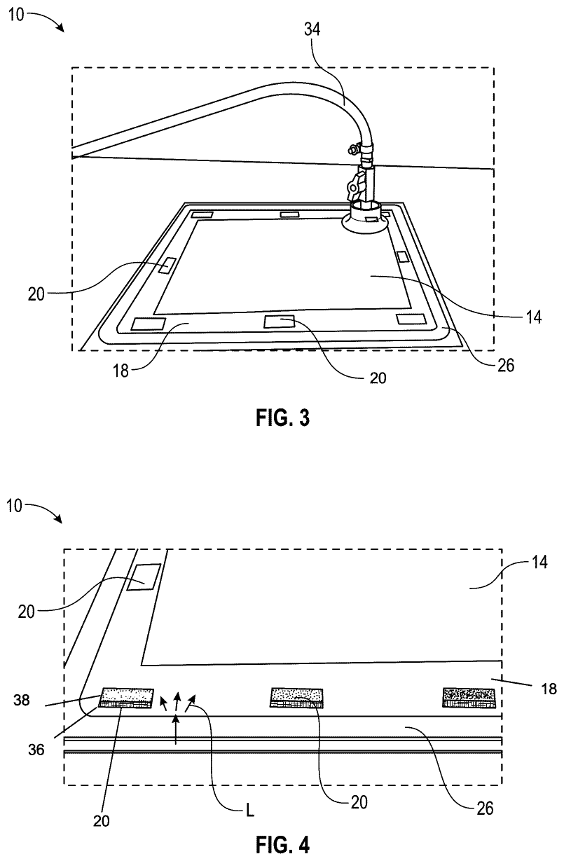

FIG. 2 shows the apparatus without a vacuum attachment, while FIG. 3 shows the apparatus with the vacuum attachment 34 (similar to FIG. 1).

Detecting oxygen concentration through luminophoric materials can indicate the overall pressure within the vacuum-sealed system. While oxygen itself is not the main concern in composite manufacturing, it serves as a useful indicator of potential air leaks in the vacuum bag assembly. The luminescent contrast indicators, as shown as small patches 20 or long strips 16, use luminescence quenching, where the brightness of light emission from the luminophoric material decreases as local oxygen concentration increases. This relationship allows for measuring oxygen partial pressure, which correlates strongly with total pressure in a system initially evacuated of air. By placing these luminescent contrast indicators 16, 20 in areas prone to leakage, technicians can monitor changes in luminescent brightness to identify localized pressure differences. These differences may point to breaches in the vacuum seal, allowing for quick identification and fixing of leaks. The sensitivity of this method enables detecting small pressure changes, potentially before they substantially impact the composite curing process, helping improve quality control and manufacturing efficiency. These indicators can, and often are the luminescent contrast indicators previously described and are representative of what might be used to test for small parts. Larger parts, such as wind turbine blade components or aircraft fuselage panels might require hundreds of indicators.

FIG. 1 and FIG. 3 show top perspective views of the vacuum bagged composite part having vacuum bag film 18 and a vacuum attachment 34 when there is no oxygen i.e., no leakage, in accordance with one exemplary embodiment of the present invention, as the luminescent contrast indicators 16, 20 is a consistent color/shade. FIG. 4 shows the feature of vacuum bag film 18 having a leakage, in accordance with one exemplary embodiment of the present invention. The luminescent contrast indicator 20 comprises a reference strip 36 and a sensor strip 38. The material of each is an oxygen-sensitive luminescent dye, and the reference strip is encased in an impermeable transparent material. The sensor strip comprises the same dye in a permeable material. The sensor strip having the permeable material is also described as the first luminophoric material, and the reference strip having the impermeable material is also described as the second luminophoric material. The above method to evaluate leakage is known as a “Contrast Method” where one luminescent contrast indicator 20 will be different intensities of brightness on the reference strip and sensor strip depending on whether oxygen (i.e. a leakage) is present. In some embodiments the reference strip 36 can be placed immediately adjacent to sensor strip 38 under the vacuum bag film 18, to allow an operator to examine sensor strip 38 using the Contrast Method. This is because reference strip 36 is adjacent to sensor strip 38, the degree to which they both are illuminated by the excitation light 30 will be substantially identical. Therefore, the differences in visual appearance between sensor strip 38 and reference strip 36 can be inferred to be due to differences in oxygen concentration, and not due to differences in excitation. This allows a visual evaluation to be more effectively conducted without a complex camera 32 and image processing software. The evaluation may be conducted in combination with or without camera 32 depending on the need. As shown in FIG. 4, if there is a leak L, near the left side (and shown as the direction of the leak with arrows), the luminescent contrast indicator 20 shows high contrast (i.e. brightness intensity) between the reference strip 36 and sensor strip 38, indicating a nearby leak. Other luminescent contrast indicators 20, shown on the bottom middle and bottom right, show less contrast difference (i.e. less difference in brightness), which indicates that the leak is not as close to those luminescent contrast indicators compared to the location of the leak relative to the luminescent contrast indicators 20 on the bottom left.

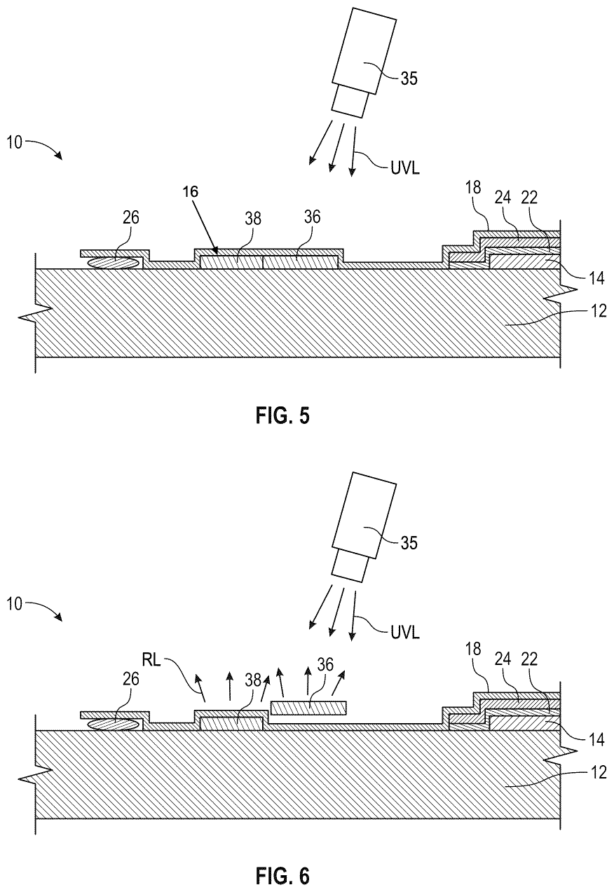

FIG. 5 shows a cross-sectional view of vacuum bagged composite part 10 during fabrication as shown in FIG. 1, but instead shows an embodiment where a reference strip 36 is disposed adjacent to the sensor strip as a Luminescent Contrast Indicator. Luminescent contrast indicators shown as small patches 20 can be replaced/used in place of luminescent contrast indicators shown as a strip 16, such as vacuum bagged composite part 10 shown in FIG. 5, and can be implemented with luminescent contrast indicators patches 20 in place of luminescent contrast indicators strips 16 without departing from the scope of the present invention. In one embodiment, rigid mold tool 12 includes a release film 22 disposed over the composite preform 14. Release film 22 functions to allow separation of the finished composite structure from surrounding a breather material 24, vacuum bag film 18, and from other materials used during the manufacturing process. As can be seen, breather material 24 is disposed over release material 22. Breather material 24 is intended to allow thorough and efficient evacuation of gas from preform 14 (or the assembly). As specified above, vacuum bag film 18 is disposed over preform 14 and luminescent contrast indicators strip 16 and sealed to rigid mold tool 12 with sealant tape 26. The air contained between vacuum bag film 18 and rigid mold tool 12 is then evacuated through vacuum attachment 34 allowing the surrounding atmospheric pressure to compress the composite preform. luminescent contrast indicators strip 16 can then be evaluated to determine the pressure under vacuum bag film 18 and to aid in determining if and where any leaks may exist. By using luminescent contrast indicators strip 16, rather than a leak detection film disposed across the entire part, the materials may be much lower cost and may be reusable.

As known, there are several ways to evaluate the sensor strips. For example, an operator uses a sensor strip, sensor disk, or a film disposed substantially over the entire assembly, as has been previously disclosed in U.S. Pat. No. 7,849,729. Optionally, a method of using an excitation light 35, a camera 32, and an image processing software has also previously been used in combination with a pressure sensitive film disposed over the part. The variations in the light emissions from the sensor strips are evaluated by the camera and software to locate potential leak locations. In practice, this type of testing is done in a dark environment to maximize the visibility of the effects being measured. The naked eye can also be used, but it has generally been too insensitive to effectively determine pressure gradients. The excitation light may be illuminating one area with greater intensity than another, as such, the variations in appearance may either be indicative of differences in oxygen concentration (indicating a leak or pressure difference) or of greater or lesser intensity in the excitation of the sensor strips.

In one example, reference strip 36 may be positioned separately outside of the vacuum bag assembly in such a way that it is adjacent to the area that will be inspected, and in such a way that it can be illuminated and inspected simultaneously with the sensor strip 38 under the vacuum bag. In one example, reference strip 36 may be attached to sensor strip 38 (such as shown in FIG. 4), or reference strip 36 may be contained within a material disposed of in a striped or other pattern. Reference strip 36 may be incorporated into an oxygen-sensitive strip 16 or patches 20, or reference strip 36 may be disposed in a broad pattern across vacuum bag film 18 that substantially covers preform 14 (such as shown in FIG. 1). In one example, vacuum bag film 18 itself can have reference strip 36, and sensor strip 38 embedded on the inward facing surface. As with the outside portable reference strip or reference strip 36, the under-the-bag reference strip 36 is designed to present a visual contrast and thus enable it to interrogate sensor strip 38 using the Contrast Method. The strip 16 or patch 20, may comprise the reference strip 36 and sensor strip 38 embedded in or encapsulated within impermeable transparent material. The reference strip 36 will vary in visual appearance based on the degree of excitation, but not based on changes in oxygen pressure. As reference strip 36 is adjacent to sensor strip 38, the degree to which they both are illuminated by the excitation light 30 will be substantially identical. Therefore, the differences in visual appearance between sensor strip 38 and reference strip 36 can be inferred to be due to differences in oxygen concentration, and not due to differences in excitation. This allows for more effective visual observation of differences in pressure.

FIG. 6 depicts an exemplary embodiment in which an external reference strip 36 is used for the Contrast Method. Here, an excitation lamp 35 is used to emit ultraviolet light (UVL) on the reference strip 36. The UVL causes reference strip 36 and sensor strip 38 to emit detectable light (either by eye or by camera). In this configuration, reference strip 36 is outside of the vacuum bag film 18, and can be relocated to whatever evaluation sensor strip 38 is undergoing. The contrasting brightness between reference strip 36 and sensor strip 38 provides the operator with an indication of the pressure (i.e. leakage due to oxygen presence), thereby inferring location of the leak source.

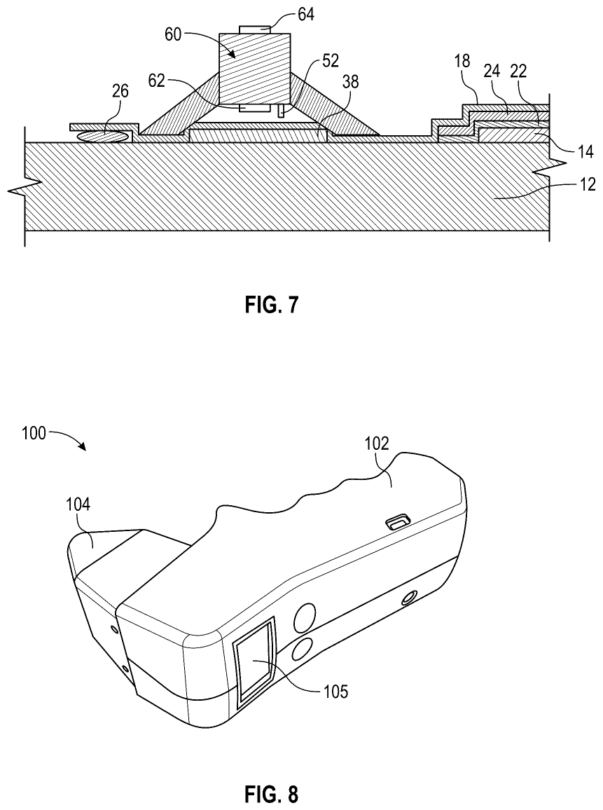

FIG. 7 shows a Discrete Luminescence Device 60 used to assess the oxygen pressure under vacuum bag film 18 utilizing a Discrete Luminescence method. Discrete Luminescence Device 60 may be termed as Discrete Luminescence Method Device 60. Discrete Luminescence Device 60 functions by blocking out ambient light in the area to be evaluated. Here, sensor strip 38 is excited with illumination source 52. Further, a photosensor 62 is used to measure the intensity of the light emitted from sensor strip 38. Photosensor 62 comprises any type of sensor including, but not limited to, a photo-voltaic, photo-emissive, photo-conductive, photo-junction, or other devices that may be used to measure the intensity of the electromagnetic wave. The output from sensor strip 38 is displayed on a screen 64 on the top surface of Discrete Luminescence Device 60. Alternatively, the output from sensor strip 38 may be displayed to the user in some other way. The Discrete Luminescence method may be accurate enough to measure the pressure under vacuum bag film 18. Discrete Luminescence Device 60 may require calibration by viewing sensor strip 38 at known pressures, but thereafter it may be possible to measure the pressure under vacuum bag film 18 using this system. No calibration is required if relative pressure is used. For example, by comparing sensor readings from various locations, these sensor readings can be used to infer relative pressure, and thereby help to locate a leak source near where the readings indicate a higher relative pressure. The portable illumination and digital photosensor device or Discrete Luminescence Device 60 may be used in combination with sensor strip 38 disposed in a strip, tape, or disk, as have been disclosed here, or they may be used in combination with a leak detection film, as previously described.

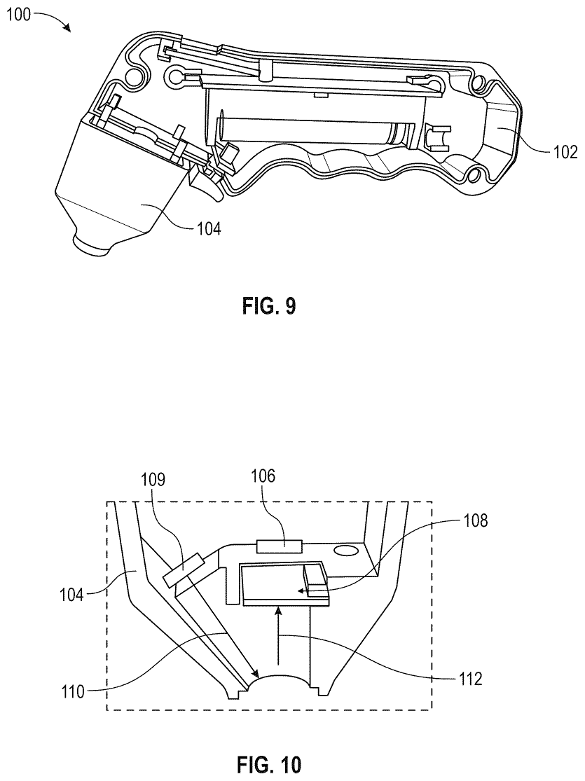

FIG. 8 and FIG. 9 show a perspective view, and a partial cut-away sectional view, respectively of a handheld Discrete Luminescent Method Device 100 for sensing local oxygen pressure. The devices shown in FIG. 8 and FIG. 9 are different embodiments of the type of device shown in FIG. 7 that can measure the readings of luminescence. The arrangement of components depicted in FIG. 7 may analogously also be in device 100 shown in FIG. 8 and FIG. 9. As can be seen, device 100 includes a body 102, a tip 104, and a screen 105. the body 102 presents a display 105 configured to show sensor reading, allowing the operator to determine a leak location inferred from brightness of the sensor strip 38. Further, FIG. 10 shows an enlarged view of tip 104. Tip 104 includes a UV light source 109 for excitation 110 of UV light towards the tip. Tip 104 includes a sensor 106, and a filter 108. The filter 108 configures to reduce noise from other ambient light sources 112. The filter 108 may be made of glass or plastic with microscopic lines applied to the surface that block some wavelengths of light. In one embodiment it is a band-pass filter that only allows light between approximately 625 nm to 674 nm through. The filter 108 may be in a preferred embodiment, but not strictly necessary for the function of the device, but may allow elimination of some amount of noise from the data. It should be understood device 100 may come in variety of form factors without deviating from the scope of the present invention.

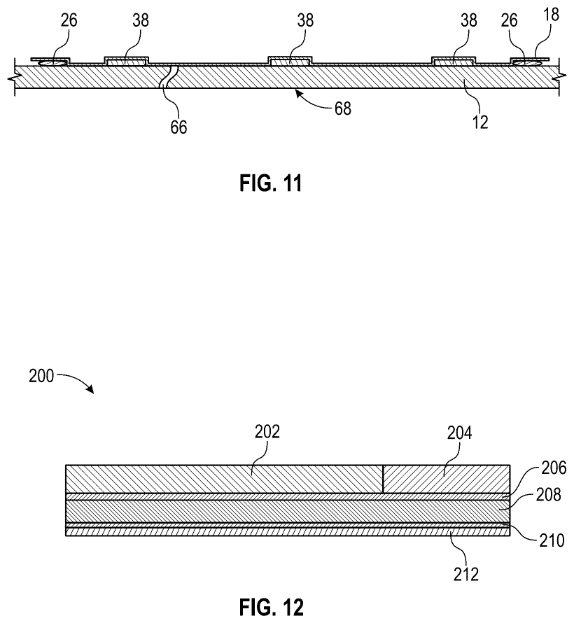

FIG. 11 shows a transparent substantially impermeable polymer film or vacuum bag film 18 used in combination with sensor strip 38 contained within a permeable solid, such as silicone rubber to detect and locate a crack or undesirable air-path 66 through a solid surface 68. sensor strip 38 may alternatively be contained within an adhesive tape. Vacuum bag film 18 is sealed to the solid surface 68 for the purpose of inspecting that surface for cracks, holes, or other defects that may allow a gas or liquid leak. This may be beneficial for applications where it is difficult to otherwise inspect for undesirable leaks. In some implementations, instead of locating leaks in a vacuum bag assembly used during the manufacture of composite components, it uses an impermeable vacuum bag to locate a leak in an underlying component. For example, a leak could be found in a welded assembly. Examples may include mold tools for composite fabrication, pressure vessels, pipes or connectors used to transmit a gas or liquid, etc. Unlike other evaluation methods, as long as there is oxygen on the side opposite the vacuum bag, no back-side access is required for testing. The various evaluation methods and configurations described previously for manufacturing applications can similarly be used for this inspection application. This application has been used with the Lifetime Method and the Intensity Method, in combination with a film disposed substantially over the entire test area, as described previously. It may be beneficial to conduct this manner of testing using the Contrast Method and the Discrete Luminescence Method. It may be beneficial to have the sensor strip embedded within an adhesive tape or reusable polymeric disk or strip.

FIG. 12 shows a cross section of a Luminescent Contrast Indicator as an embodiment construct in a tape format, used in combination with sensor material 202 (similar to sensor material 38) and reference strip 204 (reference strip 36), in accordance with one exemplary embodiment of the present invention. Luminescent Contrast Indicator 200 includes a permanent adhesive layer 206 positioned underneath sensor material 202 and reference material 204. Adhesive layer 206 rests on a backing layer 208 positioned over a second adhesive layer 210. Second adhesive layer 210 is designed to have a clean release from the surface after being exposed to high temperatures during use and can be made of silicone or rubber. Optionally, Luminescent Contrast Indicator 200 includes a liner 212 at the bottom that can be removed before use. Luminescent Contrast Indicator 200 can be used to locate leaks in vacuum bag assemblies, or it can be used for inspection surfaces for cracks, holes, or other defects that may allow a gas or liquid leak. This may be beneficial for applications where it is difficult to otherwise inspect for undesirable leaks. In one configuration

A method of detecting an oxygen leak may involve several steps utilizing luminophoric materials sensitive to oxygen. In some respects, the method may include encasing a first oxygen-sensitive luminophoric material at discrete intermittent locations in a permeable material. This may allow the luminophoric material to interact with oxygen in its surrounding environment. Additionally, a second oxygen-sensitive luminophoric material may be encased in an impermeable material, which may serve as a reference.

The method may further involve exciting both the first and second oxygen-sensitive luminophoric materials. This excitation may be achieved using an electromagnetic wave source, such as an ultraviolet light. Upon excitation, these materials may emit detectable electromagnetic waves, which can be observed or measured.

In some implementations, the method may include detecting the electromagnetic waves emitted from each of the first and second oxygen-sensitive luminophoric materials. This detection may be performed using various means, such as visual observation, a camera, or a specialized photosensor device. The intensity and characteristics of the emitted waves may vary based on the presence and concentration of oxygen.

The method may then involve contrasting the detected electromagnetic waves to provide an indication of the local oxygen pressure. This contrast may be observed visually in some cases, where differences in luminescent intensity between the permeable-encased and impermeable-encased materials can indicate variations in oxygen concentration. In other aspects, the contrast may be analyzed using image processing software or specialized electronic devices.

In some embodiments, the method may include applying the first and second oxygen-sensitive luminophoric materials to a container designed to be vacuum sealed. This application may be in the form of strips, patches, or a film covering portions of or the entire surface area of interest. The container may then be evacuated of air to create a vacuum environment.

After evacuation, the method may involve detecting electromagnetic waves emitted from the luminophoric materials under vacuum conditions. By comparing the emissions from various locations or between the permeable and impermeable encased materials, potential leak locations may be identified. Areas showing higher luminescent intensity in the permeable-encased material compared to the reference impermeable-encased material may indicate the presence of oxygen, potentially due to a leak.

In some cases, the method may utilize a photosensor to detect luminescent output from the oxygen-sensitive luminophoric materials. This approach may allow for more precise measurements of emission intensity, which can be correlated to oxygen concentration or pressure levels. The method may also involve using an electromagnetic wave source, such as a UV light, to excite the luminophoric materials in a controlled manner, ensuring consistent evaluation conditions.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

### CLAUSES

Clause 1. An apparatus for sensing local oxygen pressure, the apparatus comprising: a first luminophoric material sensitive to oxygen, encased within a permeable material; and a second luminophoric material, of a same or a similar type as the first luminophoric material, encased within an impermeable material, wherein the first luminophoric material and the second luminophoric material are placed adjacent to each other; wherein a contrast in electromagnetic waves emitted from each of the first luminophoric material and the second luminophoric material provides an indication of the local oxygen pressure.

Clause 2. The apparatus of Clause 1, wherein the first luminophoric material is characterized as a sensor strip that exhibits a change in luminescent intensity when excited by an electromagnetic wave source; wherein the change in luminescent intensity varies based on local oxygen pressure in a surrounding atmosphere; wherein the second luminophoric material is characterized as a reference strip having a different luminescent intensity when excited by the same electromagnetic wave source as the first luminophoric material, when compared to sensor strip; and wherein the different luminescent intensities of the sensor strip and the reference strip are visually distinguishable from each other by a person due to contrast of the luminescent intensity of the sensor strip and the reference strip.

Clause 3. The apparatus of Clause 2, wherein the reference strip does not change in luminescent intensity when exposed to various concentrations of local oxygen pressure at a given intensity of electronic magnetic waves.

Clause 4. The apparatus of Clause 2, wherein the second luminophoric material comprises a reference strip that emits electromagnetic waves at a constant intensity regardless of local oxygen pressure, and wherein the sensor strip emits electromagnetic waves at a different luminescent intensity in response to varying local oxygen pressures, providing a visual contrast used to evaluate local oxygen pressure differences.

Clause 5. The apparatus of Clause 1, further comprising an electromagnetic wave source configured to excite the first luminophoric material and the second luminophoric material to deduce relative local oxygen pressure.

Clause 6. The apparatus of Clause 5, further comprising a photosensor for sensing output of luminescent intensity from the first luminophoric material.

Clause 7. The apparatus of Clause 1 further comprises a camera for identifying the contrast in electromagnetic waves emitted from each of the first luminophoric material and the second luminophoric material.

Clause 8. The apparatus of Clause 1, wherein the second luminophoric material is a movable article placed on or near the first luminophoric material so both can be excited and evaluated simultaneously be the same electronic magnetic wave source.

Clause 9. The apparatus of Clause 8, where the first luminophoric material and the second luminophoric material are connected to each other, thereby forming an indicate strip.

Clause 10. The apparatus of Clause 1, wherein the second luminophoric material encased within the impermeable material is placed adjacent to the first luminophoric material; wherein the first luminophoric material is characterized as a sensor strip that exhibits a change in luminescent intensity when excited by an electromagnetic wave source, wherein the electromagnetic wave source is a ultraviolet (UV) wave source, and the change in luminescent intensity varies based on local oxygen pressure in a surrounding atmosphere; wherein the second luminophoric material is characterized as a reference strip having a luminescent intensity that remains constant regardless of oxygen concentration when excited by the same electromagnetic wave source as the first luminophoric material, such that the reference strip and sensor strip exhibit similar luminescent intensity when little or no oxygen is present, but display different luminescent intensities when oxygen is present; wherein the different luminescent intensities of the sensor strip and the reference strip are visually distinguishable from each other by a person due to contrast of the luminescent intensity of the sensor strip and the reference strip; wherein the reference strip does not change in luminescent intensity when exposed to various concentrations of local oxygen pressure at a given intensity of electromagnetic waves; wherein the reference strip emits electromagnetic waves at a constant luminescent intensity regardless of local oxygen pressure, and wherein the sensor strip emits electromagnetic waves at a different luminescent intensity in response to varying local oxygen pressures, providing a visual contrast used to evaluate local oxygen pressure differences; wherein the apparatus further comprises an electromagnetic wave source configured to excite the first luminophoric material and the second luminophoric material to deduce relative local oxygen pressure; wherein the apparatus further comprises a photosensor for sensing output of luminescent intensity from the first luminophoric material; wherein the apparatus further comprises a camera for identifying the contrast in electromagnetic waves emitted from each of the first luminophoric material and the second luminophoric material; wherein the second luminophoric material is a movable article placed on or near the first luminophoric material so both can be excited and evaluated simultaneously by the same electromagnetic wave source; and wherein the first luminophoric material and the second luminophoric material are connected to each other, thereby forming an indicator strip.

Clause 11. A system for detecting local oxygen pressure, comprising: a first luminophoric material sensitive to oxygen, encased at discreet intermittent locations within a permeable material; a second luminophoric material, of a same or a similar type as the first luminophoric material, encased within an impermeable material; and means for causing the first luminophoric material and the second luminophoric material to provide a visual indication contrast of local oxygen pressure based on the visual contrast between the first luminophoric material and the second luminophoric material.

Clause 12. The system of Clause 11, further comprising a means for detecting a luminescent intensity output of the first luminophoric material and second luminophoric material.

Clause 13. The system of Clause 11, wherein the means for causing the first luminophoric material and the second luminophoric material to provide a visual indication of contrast of local oxygen pressure is an electromagnetic wave source for exciting the first luminophoric material and the second luminophoric material.

Clause 14. The system of Clause 13, wherein the electromagnetic wave source comprises an ultraviolet wave source for activating luminophoric materials to deduce the local oxygen pressure of the first luminophoric material and the second luminophoric material.

Clause 15. The system of Clause 12, wherein the photosensor comprises a filter configured for filtering out wavelengths not emitted from the first luminophoric material.

Clause 16. The system of Clause 11, wherein means for contrasting intensity of electromagnetic waves comprises at least one of a camera and an electromagnetic wave source.

Clause 17. The system of Clause 11, wherein the second luminophoric material is positioned adjacent the first luminophoric material in a manner to determine local oxygen pressure near the first and second luminophoric material.

Clause 18. A method for detecting local oxygen pressure, the method comprising steps of: encasing a first oxygen-sensitive luminophoric material at discreet intermittent locations in a permeable material; encasing a second oxygen-sensitive luminophoric material in an impermeable material; exciting both the first oxygen-sensitive luminophoric material and the second oxygen-sensitive luminophoric material; detecting electromagnetic waves emitted from each of the first oxygen-sensitive luminophoric material and the second oxygen-sensitive luminophoric material; and contrasting the electromagnetic waves detected to provide an indication of the local oxygen pressure.

Clause 19. The method of Clause 18, further comprising the steps of: utilizing a photosensor to detect a luminescent output from the first oxygen-sensitive luminophoric material and the second oxygen-sensitive luminophoric material; utilizing an electromagnetic wave source to excite the first oxygen-sensitive luminophoric material and the second oxygen-sensitive luminophoric material; applying the first oxygen-sensitive luminophoric material and the second oxygen-sensitive luminophoric material to a container designed to be vacuum sealed; evacuating air from the container to be vacuum sealed; detecting electromagnetic waves emitted from each of the first and second oxygen-sensitive luminophoric materials; and identifying potential leak locations in the vacuumed container based on differences in the detected electromagnetic waves between the first and second oxygen-sensitive luminophoric materials.

Clause 20. An apparatus for detecting local oxygen pressure, comprising: a luminophoric oxygen-sensitive material encased in a permeable material, forming a sensor strip; and, an electronic device having: a photosensor; an excitation source; and a body configured to be placed face down over the sensor strip in a manner that creates an enclosed environment, allowing for repeatable evaluation conditions, wherein the excitation source illuminates the sensor strip, and the photosensor detects electromagnetic waves emitted from the sensor strip to provide an indication of the local oxygen pressure.

Clause 21. A method for detecting local oxygen pressure, the method comprising steps of: providing a first oxygen-sensitive luminophoric material in a permeable material; exciting the first oxygen-sensitive luminophoric material by an electromagnetic wave excitation source; detecting electromagnetic waves emitted from the first oxygen-sensitive luminophoric material; measuring intensity of electromagnetic waves emitted by the first oxygen-sensitive luminophoric material at a first position of the first oxygen-sensitive luminophoric material; measuring intensity of electromagnetic waves emitted by the first oxygen-sensitive luminophoric material at a second position of the first oxygen-sensitive luminophoric material; contrasting intensity of the electromagnetic waves emitted at the first position and the second position of the luminophoric material to provide an indication of the local oxygen pressure, identifying areas of potential leak locations based on a contrast in intensity of the electromagnetic waves emitted at the first position and the second position of the luminophoric material, thereby indicating a potential leak.

### Definitions

Luminophoric material: A substance that emits light when excited by an external energy source, such as electromagnetic radiation or chemical reactions.

Oxygen-sensitive: Capable of detecting or responding to the presence or concentration of oxygen in the surrounding environment.

Permeable material: A substance that allows gases or liquids to pass through it.

Impermeable material: A substance that does not allow gases or liquids to pass through it.

Electromagnetic wave: A type of energy that propagates through space as oscillating electric and magnetic fields.

Sensor strip: A narrow piece of material containing reactive substances used to detect or measure specific properties or conditions.

Reference strip: A standardized strip used for comparison or calibration purposes in measurement or detection systems.

Luminescent intensity: The brightness or strength of light emitted by a luminescent material.

Photosensor: A device that detects and measures light or other electromagnetic radiation.

Ultraviolet (UV) wave: Electromagnetic radiation with wavelengths shorter than visible light but longer than X-rays.

Vacuum sealed: A container or system from which air and other gases have been removed to create a low-pressure environment.

Excitation source: A device or energy source used to stimulate a material into an excited state, often resulting in the emission of light or other forms of energy.

Contrast: The difference in visual properties that makes an object distinguishable from other objects and the background.

Discrete intermittent locations: Specific, separate points or areas that are not continuous or adjacent to each other.

Electromagnetic wave source: A device or system that generates and emits electromagnetic radiation.

Filter: A device or material that selectively transmits or blocks certain wavelengths or types of radiation.

Camera: An optical instrument used to capture and record images or video.

Leak detection: The process of identifying and locating unwanted passages or openings through which gases or liquids can escape or enter a system.

Pressure gradient: The rate of change in pressure with respect to distance or position within a system.

Luminescence quenching: The decrease in light emission from a luminescent material due to interactions with other molecules or environmental factors.

Oxygen quenching: The reduction of luminescence intensity in certain materials due to collisions with oxygen molecules.

Vacuum bag: A flexible, impermeable film used to create a sealed environment for various manufacturing and processing applications.

Composite material: A material made from two or more constituent materials with significantly different physical or chemical properties that, when combined, produce a material with characteristics different from the individual components.

Breather material: A porous fabric or material used in vacuum bagging processes to facilitate air evacuation and ensure uniform pressure distribution.

Release film: A non-stick layer used in composite manufacturing to prevent adhesion between the composite material and other processing materials or tools.

What is claimed is:

1. An apparatus for sensing local oxygen pressure, the apparatus comprising:
a first luminophoric material sensitive to oxygen, encased within a permeable material; and
a second luminophoric material, of a same or a similar type as the first luminophoric material, encased within an impermeable material,
wherein the first luminophoric material and the second luminophoric material are placed adjacent to each other;
wherein a contrast in electromagnetic waves emitted from each of the first luminophoric material and the second luminophoric material provides an indication of the local oxygen pressure.

2. The apparatus of claim 1, wherein the first luminophoric material is characterized as a sensor strip that exhibits a change in luminescent intensity when excited by an electromagnetic wave source;
wherein the change in luminescent intensity varies based on local oxygen pressure in a surrounding atmosphere;
wherein the second luminophoric material is characterized as a reference strip having a different luminescent intensity when excited by the same electromagnetic wave source as the first luminophoric material, when compared to sensor strip; and
wherein the different luminescent intensities of the sensor strip and the reference strip are visually distinguishable from each other by a person due to contrast of the luminescent intensity of the sensor strip and the reference strip.

3. The apparatus of claim 2, wherein the reference strip does not change in luminescent intensity when exposed to various concentrations of local oxygen pressure at a given intensity of electronic magnetic waves.

4. The apparatus of claim 2, wherein the second luminophoric material comprises a reference strip that emits electromagnetic waves at a constant intensity regardless of local oxygen pressure, and wherein the sensor strip emits electromagnetic waves at a different luminescent intensity in response to varying local oxygen pressures, providing a visual contrast used to evaluate local oxygen pressure differences.

5. The apparatus of claim 1, further comprising an electromagnetic wave source configured to excite the first luminophoric material and the second luminophoric material to deduce relative local oxygen pressure.

6. The apparatus of claim 5, further comprising a photosensor for sensing output of luminescent intensity from the first luminophoric material.

7. The apparatus of claim 1, further comprises a camera for identifying the contrast in electromagnetic waves emitted from each of the first luminophoric material and the second luminophoric material.

8. The apparatus of claim 1, wherein the second luminophoric material is a movable article placed on or near the first luminophoric material so both can be excited and evaluated simultaneously be the same electronic magnetic wave source.

9. The apparatus of claim 8, where the first luminophoric material and the second luminophoric material are connected to each other, thereby forming an indicate strip.

10. The apparatus of claim 1, wherein the second luminophoric material encased within the impermeable material is placed adjacent to the first luminophoric material;
wherein the first luminophoric material is characterized as a sensor strip that exhibits a change in luminescent intensity when excited by an electromagnetic wave source, wherein the electromagnetic wave source is an ultraviolet (UV) wave source, and the change in luminescent intensity varies based on local oxygen pressure in a surrounding atmosphere;
wherein the second luminophoric material is characterized as a reference strip having a luminescent intensity that remains constant regardless of oxygen concentration when excited by the same electromagnetic wave source as the first luminophoric material, such that the reference strip and sensor strip exhibit similar luminescent intensity when little or no oxygen is present, but display different luminescent intensities when oxygen is present;
wherein the different luminescent intensities of the sensor strip and the reference strip are visually distinguishable from each other by a person due to contrast of the luminescent intensity of the sensor strip and the reference strip;
wherein the reference strip does not change in luminescent intensity when exposed to various concentrations of local oxygen pressure at a given intensity of electromagnetic waves;
wherein the reference strip emits electromagnetic waves at a constant luminescent intensity regardless of local oxygen pressure, and wherein the sensor strip emits electromagnetic waves at a different luminescent intensity in response to varying local oxygen pressures, providing a visual contrast used to evaluate local oxygen pressure differences;
wherein the apparatus further comprises an electromagnetic wave source configured to excite the first luminophoric material and the second luminophoric material to deduce relative local oxygen pressure;
wherein the apparatus further comprises a photosensor for sensing output of luminescent intensity from the first luminophoric material;
wherein the apparatus further comprises a camera for identifying the contrast in electromagnetic waves emitted from each of the first luminophoric material and the second luminophoric material;
wherein the second luminophoric material is a movable article placed on or near the first luminophoric material so both can be excited and evaluated simultaneously by the same electromagnetic wave source; and
wherein the first luminophoric material and the second luminophoric material are connected to each other, thereby forming an indicator strip.

11. A system for detecting local oxygen pressure, comprising:
a first luminophoric material sensitive to oxygen, encased at discreet intermittent locations within a permeable material;
a second luminophoric material, of a same or a similar type as the first luminophoric material, encased within an impermeable material; and
means for causing the first luminophoric material and the second luminophoric material to provide a visual indication contrast of local oxygen pressure based on the visual contrast between the first luminophoric material and the second luminophoric material.

12. The system of claim 11, further comprising a means for detecting a luminescent intensity output of the first luminophoric material and second luminophoric material.

13. The system of claim 11, wherein the means for causing the first luminophoric material and the second luminophoric material to provide a visual indication of contrast of local oxygen pressure is an electromagnetic wave source for exciting the first luminophoric material and the second luminophoric material.

14. The system of claim 13, wherein the electromagnetic wave source comprises an ultraviolet wave source for activating luminophoric materials to deduce the local oxygen pressure of the first luminophoric material and the second luminophoric material.

15. The system of claim 12, wherein the photosensor comprises a filter configured for filtering out wavelengths not emitted from the first luminophoric material.

16. The system of claim 11, wherein means for contrasting intensity of electromagnetic waves comprises at least one of a camera and an electromagnetic wave source.

17. The system of claim 11, wherein the second luminophoric material is positioned adjacent the first luminophoric material in a manner to determine local oxygen pressure near the first and second luminophoric material.

18. A method for detecting local oxygen pressure, the method comprising steps of:
encasing a first oxygen-sensitive luminophoric material at discreet intermittent locations in a permeable material;
encasing a second oxygen-sensitive luminophoric material in an impermeable material;
exciting both the first oxygen-sensitive luminophoric material and the second oxygen-sensitive luminophoric material;
detecting electromagnetic waves emitted from each of the first oxygen-sensitive luminophoric material and the second oxygen-sensitive luminophoric material; and
contrasting the electromagnetic waves detected to provide an indication of the local oxygen pressure.

19. The method of claim 18, further comprising the steps of:
utilizing a photosensor to detect a luminescent output from the first oxygen-sensitive luminophoric material and the second oxygen-sensitive luminophoric material;
utilizing an electromagnetic wave source to excite the first oxygen-sensitive luminophoric material and the second oxygen-sensitive luminophoric material;
applying the first oxygen-sensitive luminophoric material and the second oxygen-sensitive luminophoric material to a container designed to be vacuum sealed;
evacuating air from the container to be vacuum sealed;
detecting electromagnetic waves emitted from each of the first and second oxygen-sensitive luminophoric materials; and
identifying potential leak locations in the vacuumed container based on differences in the detected electromagnetic waves between the first and second oxygen-sensitive luminophoric materials.

20. An apparatus for detecting local oxygen pressure, comprising:
a luminophoric oxygen-sensitive material encased in a permeable material, forming a sensor strip; and,
an electronic device having:
a photosensor;
an excitation source; and
a body configured to be placed face down over the sensor strip in a manner that creates an enclosed environment, allowing for repeatable evaluation conditions,
wherein the excitation source illuminates the sensor strip, and the photosensor detects electromagnetic waves emitted from the sensor strip to provide an indication of the local oxygen pressure.

21. A method for detecting local oxygen pressure, the method comprising steps of:
providing a first oxygen-sensitive luminophoric material in a permeable material;
exciting the first oxygen-sensitive luminophoric material by an electromagnetic wave excitation source;
detecting electromagnetic waves emitted from the first oxygen-sensitive luminophoric material;
measuring intensity of electromagnetic waves emitted by the first oxygen-sensitive luminophoric material at a first position of the first oxygen-sensitive luminophoric material;
measuring intensity of electromagnetic waves emitted by the first oxygen-sensitive luminophoric material at a second position of the first oxygen-sensitive luminophoric material;
contrasting intensity of the electromagnetic waves emitted at the first position and the second position of the luminophoric material to provide an indication of the local oxygen pressure,
identifying areas of potential leak locations based on a contrast in intensity of the electromagnetic waves emitted at the first position and the second position of the luminophoric material, thereby indicating a potential leak.
